(19) United States
(12) Patent Application Publication
(10) Pub. No.: US 2005/0057678 A1
(43) Pub. Date: Mar. 17, 2005

(54) Digital camera and control method for digital camera

(76) Inventor: Tadashi Fujii, Saitama-ken (JP)

Correspondence Address: BIRCH STEWART KOLASCH & BIRCH, PO BOX 747, FALLS CHURCH, VA, 22040-0747, US

(21) Appl. No.: 10/916,477

(22) Filed: Aug. 12, 2004

(30) Foreign Application Priority Data
Sep. 11, 2003 (JP) 2003-319514

(51) Int. Cl. H04N 5/222

(52) U.S. Cl. 348/333.11

(57) ABSTRACT

The present invention provides a digital camera capable of preventing the occurrence of camera shake, and a control method for a digital camera. Digital image data representing an enlarged image, which is formed by enlarging a predetermined area of an object image by a predetermined scaling factor, is generated. This is based on digital image data representing the object image, and recorded in a recording medium. The enlarged image is displayed on an LCD, and information that instructs whether re-shooting is performed is input via an operation unit. The shutter speed is controlled to be faster by a predetermined speed when the input instruction information instructs to re-shoot.

### CROSS REFERENCE TO RELATED APPLICATION

This application claims priority under 35 U.S.C. 119 from Japanese Patent Application No. 2003-319514, the disclosure of which is incorporated by reference herein.

### BACKGROUND OF THE INVENTION

1. Field of the Invention

The present invention relates to a digital camera and a control method for a digital camera, and particularly, to a digital camera provided with a display component such as a liquid crystal display (LCD) and a control method for the digital camera.

2. Description of the Related Art

Recently, with the increase in resolutions of imaging devices such as Charge Coupled Devices (CCD) and Complementary Metal Oxide Semiconductor (CMOS) image sensors, demand is rapidly increasing for digital cameras such as digital electronic still cameras and digital video cameras.

In such digital cameras, the lower the shutter speed becomes, the more likely camera shake is to occur. Accordingly, a large number of cameras having a function for informing the user of a camera shake warning at the time of shooting have been commercialized. Nonetheless, since camera shake still occasionally occurs even in digital cameras having such functions, there has been a growing need for a technology that can easily confirm whether camera shake has occurred at the time of shooting.

Many recent digital cameras have LCDs for displaying object images at the time of shooting and reproduction, and in these types of digital cameras, the photographed or shot object image is reproduced and displayed on the LCD. Confirmation as to whether camera shake has occurred can be performed by referring to the condition of the object image as it appears on the LCD.

However, since the LCD resolution is usually lower than the resolution of the photographed object image, when the object image is displayed on the LCD, the image must be displayed by thinning the pixels constituting the object image at a rate that corresponds to the difference between the respective resolutions. This has been problematic in that the camera shake condition cannot be sufficiently confirmed by the above-described method for reproducing and displaying the object image on the LCD.

Accordingly, as a conventional technology that can be applied to solve this problem, Japanese Patent Application Laid-Open (JP-A) No. 2000-278578 discloses a technology that can reliably confirm whether the focal point of the recorded image is properly focused. When recording the image, the position where the focal point has been focused is recorded and the image is displayed by enlarging the position where the focal point has been focused when reproducing and displaying the image. By applying this technology, the user can confirm whether camera shake has occurred by referring to the enlarged displayed image.

In the invention described in JP-A No. 2000-278578, confirmation as to whether camera shake has occurred can be performed, however, there has been a problem in that the occurrence of camera shake at the time of subsequent shooting cannot be prevented.

That is, as is well-known, the lower the shutter speed at the time of photographing becomes, the more likely it is for camera shake to occur. Further, shutter speed is mainly determined in accordance with the degree of ambient brightness at the time when a photograph is taken, accordingly, camera shake is very likely to occur again when the degrees of ambient brightness at the photographing time when camera shake first occurred and at the time of the next photographing are not very different. This is particularly the case when the same photographer uses the same digital camera, since the operation conditions of the digital camera when photographing (e.g., the state of the pressing force applied to the release button, the way the camera is gripped, etc.) tend not to vary significantly. For this reason, camera shake tends to be quite noticeable.

In the technology described in the above-mentioned JP-A No. 2000-278578, the shutter speed is not taken into consideration, thus making it impossible to prevent camera shake during subsequent photographing.

### SUMMARY OF THE INVENTION

The present invention is achieved in order to solve the above-described problems and is objected to provide a digital camera capable of preventing occurrence of camera shake and a control method for a digital camera.

In order to achieve the object, a first aspect of the invention is to provide a digital camera including: a recording medium in which image information representing an object image acquired by shooting has been recorded; a generating component for generating enlarged image information representing an enlarged image formed by enlarging a predetermined area of the object image by a predetermined scaling factor based on the image information; a display component for displaying the enlarged image represented by the enlarged image information; an instruction input component for inputting instruction information for instructing whether or not re-shooting is performed according to a reference result of the enlarged image displayed by the display component; and a control component for controlling a shutter speed when shooting to be faster by a predetermined speed in the case where the instruction information is for instructing re-shooting.

According to the digital camera of the first aspect of the invention, enlarged image information representing an enlarged image formed by enlarging a predetermined area of an object image by a predetermined scaling factor is generated based on image information representing the object image acquired by shooting and recorded in a recording medium, and the enlarged image represented by the enlarged image information is displayed by the display component. Therefore, by referring to the enlarged image displayed by the display component, camera shake conditions at the time of shooting can be confirmed.

Note that, the above recording medium includes a semiconductor memory element such as a Random Access Memory (RAM), an Electrically Erasable and Programmable Read Only Memory (EEPROM), or a Flash EEPROM. The above recording medium also includes a portable recording medium such as SmartMedia, CompactFlash, an AT Attachment (ATA) card, a micro-drive, a floppy disk, a Compact Disc-Recordable (CD-R), a Compact Disc-ReWritable (CD-RW), or a magnetic optical disk. Further, the above display component includes a display such as an LCD, a CRT display, a plasma display, or an organic EL display.

In the present invention, instruction information for instructing whether or not re-shooting is performed according to a reference result of the enlarged image displayed by the display component is input by the instruction input component, and by the control component, a shutter speed when shooting is controlled to be faster by a predetermined speed in the case where the instruction information is for instructing re-shooting.

That is, the case where the instruction information for instructing re-shooting is input by the instruction input component is the case where camera shake has occurred, and there is a high possibility that camera shake occurs again if shooting is performed again at the unchanged shutter speed.

Accordingly, in the invention, the shutter speed is made faster than before in the case where the re-shooting is instructed, and as a result, camera shake at the time of subsequent shooting can be prevented.

As described above, according to the digital camera of the first aspect of the invention, since enlarged image information representing an enlarged image formed by enlarging a predetermined area of an object image by a predetermined scaling factor is generated based on image information representing the object image acquired by shooting and recorded in a recording medium, the enlarged image represented by the generated enlarged image information is displayed, instruction information for instructing whether or not re-shooting is performed according to a reference result of the displayed enlarged image is allowed to input, and a shutter speed when shooting is controlled to be faster by a predetermined speed in the case where the input instruction information is for instructing re-shooting, camera shake can be prevented.

It is preferable that the control component of the invention further controls the image information to be deleted from the recording medium in the case where the instruction information is for instructing re-shooting. Thereby, image information that becomes unnecessary due to re-shooting can be deleted from the recording medium, and unwanted reduction of residual memory capacity of the recording medium can be prevented.

In the case where the shutter speed is made faster in the invention, exposure amount is reduced by the increase in the speed, and thereby, there is a possibility that shooting in suitable exposure conditions can not be performed.

Accordingly, it is preferable that the control component of the invention further controls the mode to shift to a shutter priority automatic exposure mode in the case where the instruction information is for instructing re-shooting. Thereby, aperture conditions are controlled according to the increasing shutter speed, and shooting in suitable exposure conditions can be reliably performed.

Furthermore, in the invention, it is preferable that the image information is acquired by performing focusing control with a preset focusing area as a target, and the predetermined area is an area including a part or the entire of the focusing area. Thereby, since camera shake conditions can be confirmed by referring to the enlarged image in the focused area, the camera shake conditions can be confirmed more reliably.

On the other hand, a second aspect of the invention is to provide a control method for a digital camera including: generating enlarged image information representing an enlarged image formed by enlarging a predetermined area of an object image by a predetermined scaling factor based on image information representing the object image acquired by shooting and recorded in a recording medium; displaying the enlarged image represented by the generated enlarged image information; inputting instruction information for instructing whether or not re-shooting is performed according to the reference result of the displayed enlarged image; and controlling a shutter speed when shooting to be faster by a predetermined speed in the case where the input instruction information is for instructing re-shooting.

Therefore, according to the control method of the digital camera of the second aspect of the invention, since the digital camera can be allowed to operate similarly to the first aspect, occurrence of camera shake can be prevented similarly to the first aspect.

According to the digital camera and the control method for the digital camera of the invention, since enlarged image information representing an enlarged image formed by enlarging a predetermined area of an object image by a predetermined scaling factor is generated based on image information representing the object image acquired by shooting and recorded in a recording medium, the generated enlarged image represented by the enlarged image information is displayed, instruction information for instructing whether or not re-shooting is performed according to a reference result of the displayed enlarged image is allowed to input, and a shutter speed when shooting is controlled to be faster by a predetermined speed in the case where the input instruction information is for instructing re-shooting, an advantage that camera shake can be prevented can be obtained.

### BRIEF DESCRIPTION OF THE DRAWINGS

FIG. 1 is an outline view showing the appearance of a digital camera according to an embodiment of the present invention.

FIG. 2 is a block diagram showing the configuration of an electrical system of the digital camera.

FIG. 3 is a diagram showing the configuration of an image file according to an embodiment of the invention.

FIG. 4 is a flowchart showing the processing flow of a reproduction mode processing program according to an embodiment of the invention.

FIG. 5 is a schematic view showing an example of a display condition of the normal display screen according to an embodiment of the invention.

FIG. 6 is a schematic view showing an example of a display condition of the enlarged display screen according to an embodiment of the invention.

### DETAILED DESCRIPTION OF THE INVENTION

Hereinafter, preferred embodiments for implementing the present invention will be described in detail with reference to the drawings.

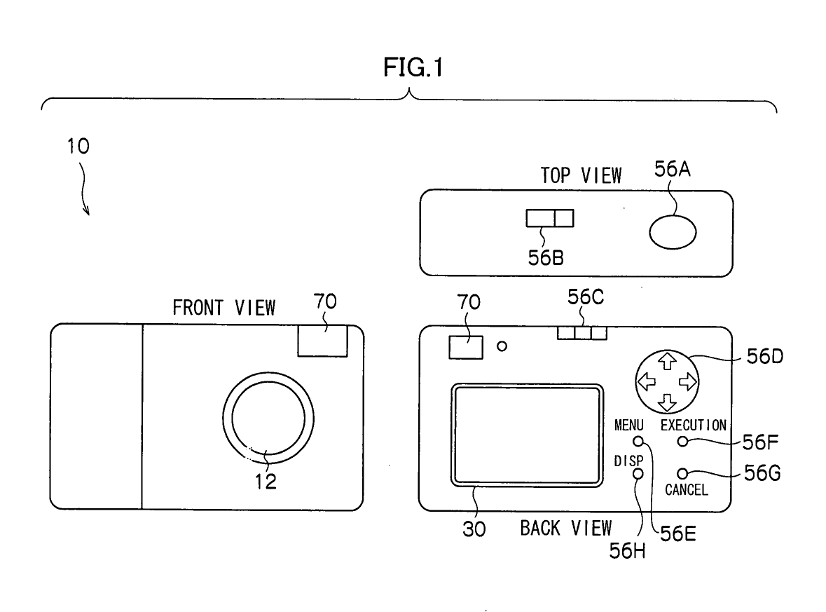

First, referring to FIG. 1, outer configuration of a digital camera according to this embodiment will be described. As shown in the same drawing, on the front surface of the digital camera 10, a lens 12 for forming an object image and a finder 70 used for determining a composition of an object to be photographed or shot are provided. Further, on the top face of the digital camera 10, a release button 56A and power switch 56B are provided. The release button 56A is operated by being pressed by the user when shooting or photographing.

Note that the release button 56A according to the embodiment is arranged so as to detect the pressing operation state of two stages. One state is when the button is pressed into the intermediate position (hereinafter, referred to as “half-pressed condition”) and the other state is when the button is pressed into the final pressed position exceeding the intermediate position (hereinafter, referred to as “fully-pressed condition”)

In the digital camera 10 according to the embodiment, after the user sets the exposure conditions (shutter speed and aperture condition) by making the release button 56A in the half-pressed condition to work the Automatic Exposure (AE) function, focusing is controlled by the Auto Focus (AF) function, and then, subsequently the user can perform exposure (shooting or photographing) by pressing the button into the fully-pressed condition.

The digital camera 10 according to the embodiment can be selectively set to either the shutter priority AE mode in which a suitable f-number is automatically determined by the designated shutter speed value and the object brightness, or the aperture priority AE mode in which a suitable shutter speed is automatically determined by the designated f-number and the object brightness, and in the case where the AE function works, the exposure conditions are set in the preset AE mode.

On the other hand, on the back face of the digital camera 10, an eyepiece portion of the above-described finder 70, an LCD 30 for displaying the object image represented by the digital image data that has been obtained by shooting, various menu panels, a message etc., a mode changing-over switch 56C to be slidingly operated for setting either the shooting mode as a mode in which shooting is performed or the reproduction mode as a mode in which the object image represented by the digital image data that has been obtained by shooting is displayed (reproduced) on the LCD 30, and a cross cursor button 56D constituted by including four arrow keys indicating the four moving directions of up, down, left, and right in the display area of the LCD 30 are provided.

Further, on the back surface of the digital camera 10, a menu key 56E that is operated by being pressed when displaying the main menu panel on the LCD 30 is fitted. An execution key 56F that is operated by being pressed when executing the processing designated on the menu panel is also provided, along with a cancel key 56G that is pressed when canceling various operations. The back surface also has a DISP key 56H that is pressed when allowing the LCD 30 to display the image.

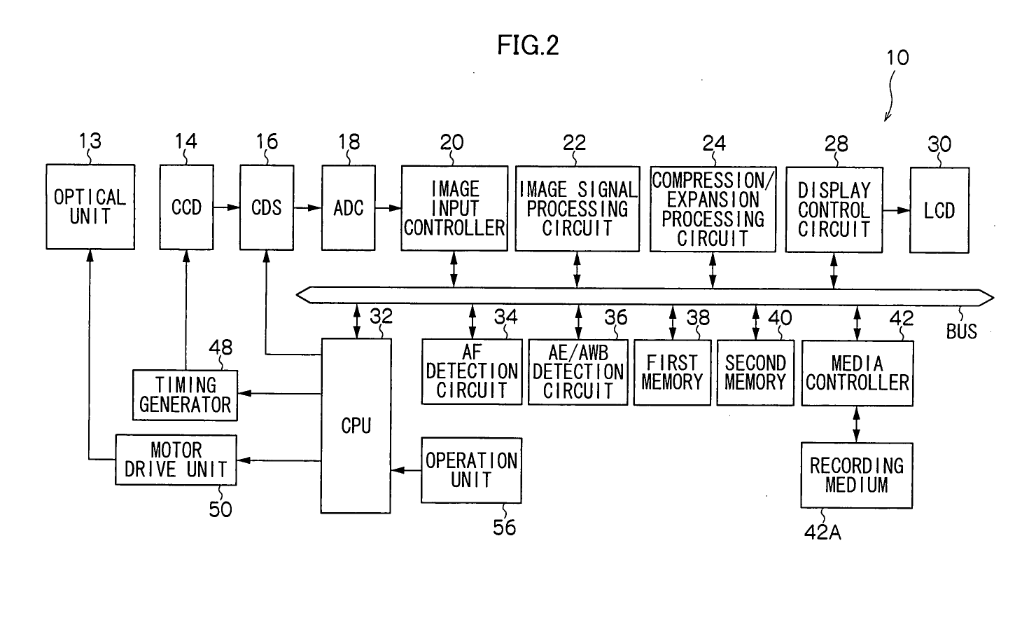

Next, referring to FIG. 2, the constitution of the electrical system of the digital camera 10 according to the embodiment will be described.

As shown in the same drawing, the digital camera 10 comprises an optical unit 13 including the above-described lens 12, a CCD 14 disposed at the rear of the optical axis of the lens 12, a correlation double sampling circuit (hereinafter, referred to as “CDS”) 16, and an analog-to-digital converter (hereinafter, referred to as “ADC”) 18 for converting the input analog signal into digital data, and the output terminal of the CCD 14 is connected to the input terminal of the CDS 16 and the output terminal of the CDS 16 is connected to the input terminal of the ADC 18, respectively.

The correlation double sampling processing by the CDS 16 is processing of obtaining accurate pixel data by taking the difference between the field through component level and the image signal component level included in the output signal with respect to each pixel of the solid state image sensing device with the aim to reduce noise (especially, thermal noise) and the like included in the output signal of the solid state image sensing device.

The digital camera 10 comprises an image input controller 20 having a line buffer of predetermined capacity built-in, for controlling the input digital image data to be stored directly in a predetermined area of a second memory 40, which will be described later. The digital camera 10 also comprises an image signal processing circuit 22 for performing various kinds of processing on the digital image data, a compression/expansion processing circuit 24 for performing compression processing on the digital image data in a predetermined compression format, while performing expansion processing on the compression processed digital image data, and a display control circuit 28 for generating a signal for displaying an image represented by the digital image data, a menu panel, etc. on the LCD 30 and supplying it to the LCD 30. Note that the input terminal of the image input controller 20 is connected to the output terminal of the ADC 18.

Further, the digital camera 10 comprises a central processing unit (CPU) 32 for controlling the entire operation of the digital camera 10, an AF detection circuit 34 for detecting physical quantity (in the embodiment, an AF evaluation value representing high frequency component of brightness of the image obtained by imaging by the CCD 14) required for working the AF function, an AE/AWB detection circuit 36 for detecting physical quantity (in the embodiment, an amount representing brightness of the image obtained by imaging by the CCD 14) required for working the AE function and the Automatic White Balance (AWB) function, a first memory 38 constituted by a Synchronous Dynamic Random Access Memory (SDRAM) used as a work area when executing various kinds of processing by the CPU 32 and the like, and a second memory 40 constituted by a Video RAM (VRAM) for storing the digital image data obtained mainly by imaging.

Furthermore, the digital camera 10 comprises a media controller 42 for making a recording medium 42A constituted by Smart Media accessible in the digital camera 10.

The above-described image input controller 20, image signal processing circuit 22, compression/expansion processing circuit 24, display control circuit 28, CPU 32, AF detection circuit 34, AE/AWB detection circuit 36, first memory 38, second memory 40, and media controller 42 are connected to one another via buses BUS, respectively.

Therefore, the CPU 32 can perform control of the respective actuations of the image input controller 20, the image signal processing circuit 22, the compression/expansion processing circuit 24, and the display control circuit 28, acquisition of physical quantity detected by the AF detection circuit 34 and the AE/AWB detection circuit 36, access to the first memory 38 and the second memory 40, and access to the recording medium 42A via the media controller 42, respectively.

Note that the CPU 32 can acquire an AF evaluation value in an arbitrary split area within an image by designating a part of an area of the shot image as an area (hereinafter, referred to as “focus area”) of the detection target of the AF evaluation value to the AF detection circuit 34. That is, the digital camera 10 according to the embodiment has a function of designating the focus area by the user.

The digital camera 10 is provided with a timing generator 48 for generating a timing signal for driving mainly the CCD 14 and supplying it to the CCD 14. The input terminal of the timing generator 48 is connected to the CPU 32 and the output terminal thereof is connected to the CCD 14, respectively, and the drive of the CCD 14 is controlled by the CPU 32 via the timing generator 48.

Furthermore, the CPU 32 is connected to the input terminal of a motor drive unit 50, and the output terminal of the motor drive unit 50 is connected to a focal point adjustment motor, a zoom motor, and an aperture drive motor provided in the optical unit 13.

The lens 12 included in the optical unit 13 according to the embodiment has multiple lenses, and is constituted as a zoom lens capable of varying the focal length (varying scale), and includes a lens drive mechanism. The lens drive mechanism includes the above-described focal point adjustment motor, zoom motor, and aperture drive motor. The focal point adjustment motor, the zoom motor, and the aperture drive motor are driven by drive signals supplied from the motor drive unit 50 under the control of the CPU 32, respectively.

The CPU 32 changes the focal length of the lens 12 included in the optical unit 13 by controlling the drive of the zoom motor when varying the optical zoom scale.

Further, the CPU 32 performs focusing control by drivingly control the above-described focal point adjustment motor so that the contrast of the image obtained by the imaging by the CCD 14 may become the maximum. That is, in the digital camera 10 according to the embodiment, as the focusing control, the so-called Through The Lens (TTL) system for setting the lens position so that the read image contrast may become the maximum is adopted.

Furthermore, an operation unit 56 including the above-described release button 56A, power switch 56B, mode change-over switch 56C, cross cursor button 56D, menu key 56E, execution key 56F, cancel key 56G, and DISP key 56H is connected to the CPU 32, and the CPU 32 can constantly grasp the operation conditions of the respective parts of the operation unit 56.

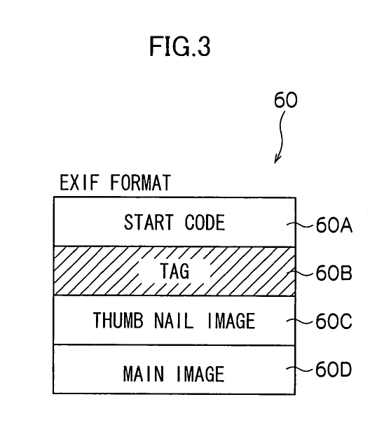

Note that the digital camera 10 according to the embodiment meets Exchangeable Image File Format (EXIF) standard, and the digital image data obtained by shooting is stored in the recording medium 42A as a computerized file (image file) of EXIF standard. By setting in advance the information desired to be stored in the tag area included in the image file of EXIF standard on the main menu panel displayed on the LCD 30 in response to the pressing operation of the menu key 56E, the information can be stored in the tag area (FIG. 3) of the image files obtained by subsequent shooting.

That is, as shown in FIG. 3, in the digital camera 10 according to the embodiment, since an image file 60 obtained by shooting and to be stored in the recording medium 42A meets EXIF standard, a start code area 60A, a tag area 60B, a thumb nail image area 60C, and a main image area 60D are included therein. Here, in the tag area 60B, various kinds of information preset on the main menu panel are stored.

Note that, as information that can be stored in the tag area 60B, in the embodiment, shooting information (information representing use/nonuse of flash, information representing aperture conditions, information representing shooting data and time, etc.) relating to shooting for obtaining the image file, information representing shooting conditions (manual shooting, auto shooting, program shooting, macro shooting, movable body shooting, night scene shooting, portrait shooting, etc.) that have been set in the digital camera 10, and the like are constituted so as to be set in advance.

Further, in the digital camera 10 according to the embodiment, information representing the position of the focus area (hereinafter, referred to as “focus area information”) applied when shooting has been set in advance to be stored in a predetermined area of the tag area 60B. Note that, in the embodiment, as the focus area information, coordinate information representing the position of the focus area on the digital image data included in the image file is stored.

Next, the operation of the digital camera 10 according to the embodiment will be described. First, the overall processing flow in the case where the shooting mode is set will be described.

First, the CCD 14 picks up an image via the optical unit 13, and signals representing the object image are subsequently output from the CCD 14. Then, the signals output from the CCD 14 are sequentially input to the CDS 16 and subjected to correlation double sampling processing, and input to the ADC 18. The ADC 18 converts the signals of R (red), G (green), and B (blue) input from the CDS 16 into 12-bit R, G, B signals (digital image data), respectively, and outputs them to the image input controller 20.

The image input controller 20 accumulates the digital image data sequentially input from the ADC 18 in the built-in line buffer, and stores them once in a predetermined area of the second memory 40.

The digital image data stored in the predetermined area of the second memory 40 is read out by the image signal processing circuit 22 under the control by the CPU 32, and white balance adjustment is performed by multiplying them by digital gain according to the physical quantity detected by the AE/AWB detection circuit 36, gamma processing and sharpness processing are performed thereon to generate 8-bit digital image data, and further, YC signal processing is performed to generate brightness signals Y and chroma signals Cr and Cb (hereinafter, referred to as “YC signals”) and the YC signals are stored in a different area from the above-described predetermined area of the second memory 40.

Note that the LCD 30 is arranged so as to display a motion image (through image) obtained continuous image pick-up by the CCD 14 and to be used as a finder, and in the case where the LCD 30 is used as a finder, the generated YC signals are sequentially output to the LCD 30 via the display control circuit 28. Thereby, the through image is displayed on the LCD 30.

Here, in the case where the release button 56A is made into the half-pressed condition by the user, after the exposure condition is set by the working of the AE function as described above, focusing is controlled by the working of the AF function, and then, in the case where the full-pressed condition is made subsequently, the YC signals stored in the second memory 40 at this time are compressed in a predetermined compression format (in the embodiment, JPEG format) by the compression/expansion processing circuit 24, and then, stored in the recording medium 42A as an image file of EXIF standard. Simultaneously, in the tag area of the image file, information that has been set as information to be stored in the tag area on the main menu panel in advance is stored.

In the digital camera 10 according to the embodiment, since the focus area information has been set to be stored in the tag area in advance, the image file obtained by shooting becomes a file in which at least focus area information is stored in the tag area.

Note that, when operating the release button 56A, the user designates the desired focus area if necessary by the operation of the cross cursor button 56D. Thereby, an image focused in the desired position can be obtained. When the focus area is not designated by the user, an area in a predetermined size including the center of the shot image is applied as a default focus area.

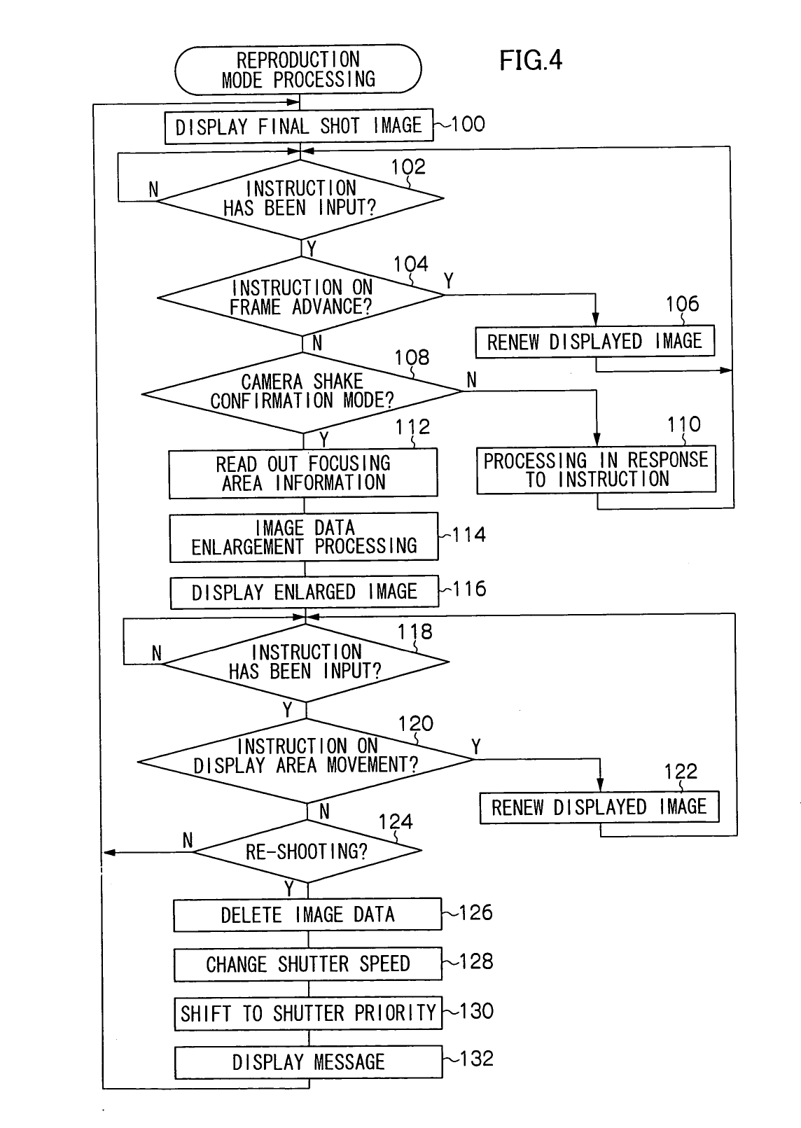

Next, overall processing flow in the case where the reproduction mode is set will be described by referring to Fig. 4. FIG. 4 is a flowchart showing the processing flow of the reproduction mode processing program executed by the CPU 32 of the digital camera 10 when the reproduction mode is set.

First, in step 100, the object image represented by the image file obtained by the last shooting in the image files stored in the recording medium 42A is reproduced on the LCD 30. Note that the image file obtained by the last shooting can be specified as an image file representing the latest date and time by referring the updated date information and updated time information corresponding to all image files in the directory of the recording medium 42A. Further, a mode in which an image file is specified by setting in advance so as to store the information representing the shooting date and time in the tag areas of the respective image files and referring to the information, may be adopted.

In FIG. 5, an example of the image displayed on the LCD 30 by the processing of the step 100 is shown. As shown in the same drawing, as the image, in the digital camera 10 according to the embodiment, the object image represented by the image file obtained by the last shooting is displayed, and a message showing that the key for instructing the shift to the camera shake confirmation mode as a mode for confirming the condition of camera shake of the displayed object image is the DISP key 56H, is displayed.

When the image is displayed on the LCD 30, the user operates the DISP key 56H by pressing it when instructing the shift to the camera shake confirmation mode. Further, when the user instructs frame advance of object images displayed on the LCD 30, the user presses the left direction arrow key of the cross cursor button 56D when an object image prior to the object image being displayed at the time is allowed to be displayed, and the user presses the right direction arrow key of the cross cursor button 56D when an object image posterior to the object image being displayed at the time is allowed to be displayed. Furthermore, in the case where the user instructs execution of processing other than the shift to the camera shake confirmation mode and frame advance, the user performs operation for instructing the execution of the processing. When the above-described operation by the user is performed, the instruction information corresponding to the operation is input to the CPU 32.

Accordingly, in the next step 102, instruction operation wait by the user is performed by performing input wait of the instruction information, and, in the next step 104, whether or not the instruction by the user has been frame advance is judged, if positively judged, shifting to step 106, the object image being displayed on the LCD 30 is updated in response to the key operated by the user (in the embodiment, the left direction arrow key or the right direction arrow key of the cross cursor button 56D) , and then, the processing is returned to the above step 102.

On the other hand, if negatively judged in the step 104, shifting to step 108, whether or not the instruction by the user has been the shift to the camera shake confirmation mode is judged, and if negatively judged, shifting to step 110, after executing the processing in response to the instruction by the user, the processing is returned to the step 102, or if positively judged, the processing is shifted to step 112.

In step 112, focus area information is read out from the tag area 60B of the image file corresponding to the object image being displayed on the LCD 30, and in the next step 114, pixel data group corresponding to the area that includes the position of the focus area represented by the read out focus area information and is a rectangular area in a predetermined size is read out from the main image area 60D in the image file, and enlargement processing for enlarging the image represented by the image data group by a predetermined scaling factor is performed.

Note that, in the embodiment, as the size of the rectangular area, 15% size relative to the respective longitudinal and lateral sizes in the object image displayed on the LCD 30 is applied. Further, in the embodiment, as the above predetermined scaling factor, six times relative to the longitudinal and lateral sizes of the object image is applied. Therefore, the displayed size of the object image obtained by the enlarging processing on the LCD 30 becomes an area of 90% (=15%×6 times) relative to the displayed size of the entire object image.

Further, in the embodiment, as the technique of the enlargement processing, a technique for laterally and longitudinally arranging pixel data of the pixel as many as the number of the scaling factor with respect to each pixel of the pixel data group is applied. Thereby, compared to the case of applying the technique for generating the pixel data after enlargement processing between the respective pixels by interpolation processing, which is generally performed in the electronic zoom (also referred to digital zoom) that has been adopted conventionally and widely in the digital camera field, it becomes easier to judge camera shake conditions.

In the next step 116, enlarged image represented by the digital image data that has been obtained by the processing by the above step 114 is displayed on the LCD 30.

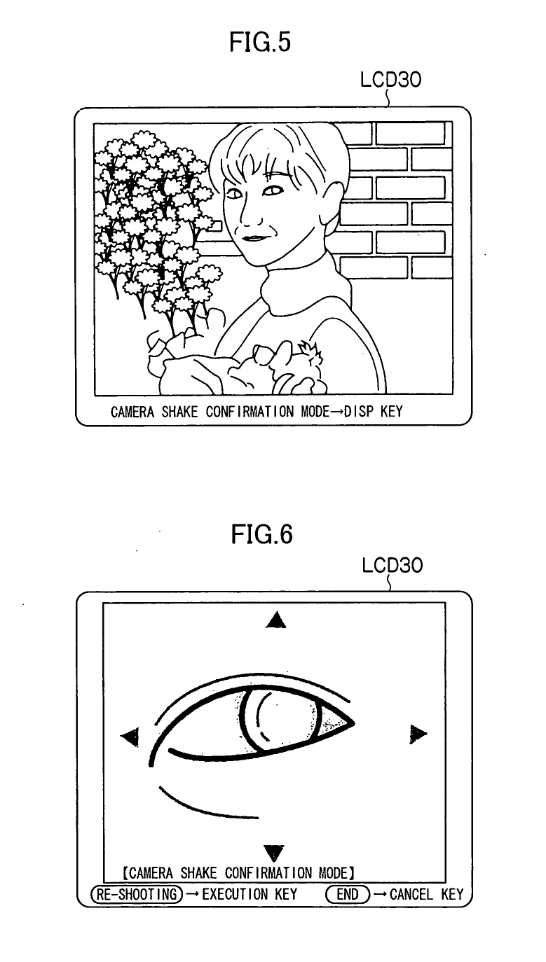

In FIG. 6, an example of the image displayed on the LCD 30 by the processing of the step 116 is shown. As shown in the same drawing, as the image, in the digital camera 10 according to the embodiment, the above-described enlarged image is displayed and the message saying that the camera shake confirmation mode is executing is displayed. Further, four marks indicating the scroll directions of up, down, left, and right (in the same drawing, isosceles triangles indicating the scroll directions by the directions of apexes) are displayed in the vicinity of the periphery of the enlarged image, respectively, and under the enlarged image, the message saying that the key for instructing re-shooting is the execution key 56F and the key for instructing ending of the camera shake confirmation mode is the cancel key 56G is displayed.

When the image is displayed on the LCD 30, the user pressingly operates the arrow key of the cross cursor button 56D indicating the same direction as the scroll direction indicated by the marks if the enlarged image is scrolled. Further, in the case where the user judges that re-shooting is performed as a result of referring to the enlarged image for the reasons such that the degree of camera shake is too high, he/she pressingly operates the execution key 56F. Furthermore, in the case where the user judges that the camera shake confirmation mode is ended without performing re-shooting as a result of referring to the enlarged image for the reasons such that the degree of camera shake is not too high, he/she pressingly operates the cancel key 56G. When the above-described operation by the user is performed, the instruction information in response to the operation is input to the CPU 32.

Accordingly, in the next step 118, instruction operation wait by the user is performed by performing input wait of the instruction information, and in the next step 120, whether or not the instruction by the user has been scroll display of the enlarged image is judged, if positively judged, shifting to step 122, the enlarged image being displayed on the LCD 30 is updated by performing processing for scroll displaying the enlarged image being displayed on the LCD 30 in the direction in response to the key operated by the user (in the embodiment, arrow keys of the respective directions of the cross cursor button 56D), and then, the processing is returned to the above step 118.

On the other hand, if negatively judged in the step 120, shifting to step 124, whether or not the instruction by the user has been the re-shooting is judged, and if negatively judged, the instruction by the user is judged that it has been ending of the camera shake confirmation mode, the processing is returned to the step 100, and, if positively judged, the processing is shifted to step 126.

In the step 126, the image file corresponding to the enlarged image being displayed on the LCD 30 is deleted from the recording medium 42A, and in the next step 128, the shutter speed is set so as to be faster by predetermined speed (here, the speed corresponding to 10% in the variable range of the shutter speed) than the speed set at that time. Note that, in the embodiment, the shutter speed is made higher by making the mechanical shutter speed higher. However, the invention is not limited to that, the mode in which the shutter speed is made higher by making the electronic shutter speed higher, or the mode in which the shutter speed is made higher by making the speed of both the mechanical shutter and the electronic shutter higher may be adopted.

In the next step 130, the AE mode of the digital camera 10 is shifted to the shutter priority AE mode, and in the next step 132, the message saying that the AE mode has been shifted to the shutter priority AE mode is displayed on the LCD 30, and then, the processing is returned to the step 100.

Note that the execution of the reproduction mode processing is completed at the time when the power switch 56B of the digital camera 10 is turned off.

Further, in the case where instruction of re-shooting is input on the enlarged screen (see FIG. 6) displayed on the LCD 30 by the processing of step 116 in the reproduction mode processing, the user shoots again after setting the mode to the shooting mode. At the time, since the digital camera 10 sets the shutter speed to be faster than before by the processing subsequent to the step 128 in the reproduction mode processing, occurrence of camera shake can be prevented.

As described above in detail, in the embodiment, in the case where the digital image data representing an enlarged image formed by enlarging a predetermined area of an object image by a predetermined scaling factor is generated based on digital image data representing the object image acquired by shooting and recorded in a recording medium 42A, the enlarged image represented by the generated digital image data is displayed, instruction information for instructing whether or not re-shooting is performed according to the reference result of the displayed enlarged image is allowed to input, and a shutter speed when shooting is controlled to be faster by a predetermined speed in the case where the input instruction information is for instructing re-shooting, occurrence of camera shake can be prevented.

Further, in the embodiment, in the case where the above instruction information is for instructing re-shooting, since the image file corresponding to the enlarged and displayed digital image data is controlled to be deleted from the recording medium 42A, image information to be unnecessary because of re-shooting can be deleted from the recording medium 42A, and unwanted reduction of residual memory capacity of the recording medium 42A can be prevented.

Further, in the embodiment, in the case where the above instruction information is for instructing re-shooting, since shift to the shutter priority AE mode is controlled, aperture conditions are controlled according to the increasing shutter speed, and shooting in suitable exposure conditions can be reliably performed.

Further, in the embodiment, since the enlarged image is the area including the focusing area, camera shake conditions can be confirmed by referring to the enlarged image in the focused area, the camera shake conditions can be confirmed more reliably.

Note that, in the embodiment, the case where the focus area information has been stored in the tag area in the image file of EXIF standard is described, the invention is not limited to that, and, for example, a mode in which the information is included in the file name of the image file, or a mode in which the information has been stored by relating to the corresponding image file by another computerized file (text file as an example) different from the image file may be adopted. In this case, the same effect as the embodiment can also be exerted.

Further, in the embodiment, the case where the DISP key 56H is applied as a key for instructing shift to the camera shake confirmation mode is described, however, the invention is not limited to that, and, for example, a mode in which an AF/MF switching button or a one-push AF button, which is often provided to relatively high class models, is applied can be adopted. In this case, the same effect as the embodiment can also be exerted.

Further, the constitution of the digital camera 10 (see FIGS. 1 and 2) according to the embodiment is only an example, and changes can be made suitably within the range without departure from the sense of the invention.

Furthermore, the processing flow of the reproduction mode processing program (see FIG. 4) described in the embodiment is only an example, and changes can be made suitably within the range without departure from the sense of the invention.

1. A digital camera comprising:
a recording medium in which image information representing an object image acquired by shooting is recorded;
a generating component for generating enlarged image information representing an enlarged image formed by enlarging a predetermined area of the object image by a predetermined scaling factor based on the image information;
a display component for displaying the enlarged image represented by the enlarged image information;
an instruction input component for inputting instruction information for instructing whether re-shooting is performed in accordance with a reference result corresponding to the enlarged image displayed on the display component; and
a control component for controlling a shutter speed when shooting so as to be faster by a predetermined speed in the case where the instruction information instructs to re-shoot.

2. The digital camera of claim 1, wherein the control component controls the image information to be deleted from the recording medium in the case where the instruction information instructs to re-shoot.

3. The digital camera of claim 1, wherein the control component controls the mode to shift to a shutter priority automatic exposure mode in the case where the instruction information instructs to re-shoot.

4. The digital camera of claim 1, wherein
the image information is acquired by performing focusing control with a preset focusing area as a target, and
the predetermined area is an area including a part of or the entire focusing area.

5. The digital camera of claim 1, wherein the generating component generates the enlarged image information by arranging, in lateral and longitudinal directions, pixel data to each pixel of the image data of the object image such that the number of pixel data for each pixel is the number of a value of the predetermined scaling factor.

6. The digital camera of claim 1, wherein the predetermined speed is a speed corresponding to 10% of a variable range of the shutter speed.

7. A control method for a digital camera comprising:
(a) generating enlarged image information representing an enlarged image formed by enlarging a predetermined area of an object image by a predetermined scaling factor based on image information representing the object image acquired by shooting and recorded in a recording medium;
(b) displaying the enlarged image represented by the generated enlarged image information;
(c) inputting instruction information for instructing whether re-shooting is performed in accordance with the reference result corresponding to the displayed enlarged image; and
(d) controlling a shutter speed when shooting to be faster by a predetermined speed in the case where the input instruction information instructs to re-shoot.

8. The control method for a digital camera of claim 7, wherein in (d), the image information is controlled to be deleted from the recording medium in the case where the instruction information instructs to re-shoot.

9. The control method for a digital camera of claim 7, wherein in (d), the mode is controlled to shift to a shutter priority automatic exposure mode in the case where the instruction information instructs to re-shoot.

10. The control method for a digital camera of claim 7, wherein
the image information is acquired by performing focusing control with a preset focusing area as a target, and
the predetermined area is an area including a part of or the entire focusing area.
